(19) United States
(12) Patent Application Publication
(10) Pub. No.: US 2025/0148973 A1
(43) Pub. Date: May 8, 2025

(54) DISPLAY DRIVER IC FOR IMAGE CORRECTION OF AMOLED

(71) Applicant: BLOSSOM TECHNOLOGY INC., Seongnam-si, Gyeonggi-do (KR)

(72) Inventor: Koan Yel JEONG, Yongin-si, Gyeonggi-do (KR)

(73) Assignee: BLOSSOM TECHNOLOGY INC., Seongnam-si, Gyeonggi-do (KR)

(21) Appl. No.: 18/874,437

(22) PCT Filed: Nov. 5, 2021
(86) PCT No.: PCT/KR2021/016032

§ 371 Date: Jan. 23, 2025

(30) Foreign Application Priority Data
Nov. 5, 2021 (KR) 10-2021-0151003

(51) Int. Cl. G09G 3/3225

(52) U.S. Cl. CPC G09G 3/3225; G09G 2320/0233; G09G 2320/0257

(57) ABSTRACT

The present invention relates to a display driver IC for AMOLED image correction optimized for external compensation to solve problems such as MURA and image sticking of an AMOLED panel, and more specifically, to a display driver IC for AMOLED image correction, which comprises a first compensation circuit section, a conversion circuit section, a second compensation circuit section, and a driving circuit section, and obtains compensation data for luminous efficiency deviation rate (ΔLU) of a light-emitting diode and beta value deviation rate (ΔBeta) of a thin film transistor in a gamma curve domain between luminance and video data, and compensates for threshold voltage deviation rate (ΔVT) of a thin film transistor by obtaining compensation data in a gamma curve domain between luminance and driving voltage and then adding them up.

### TECHNICAL FIELD

This invention relates to a display driver IC (integrated circuit) for correcting image of and active matrix OLED (hereinafter referred to as AMOLED), and more particularly, to a display driver IC for correcting image of the active matrix OLED optimized for external compensation to solve problems such as MURA and image sticking of the active matrix OLED panel.

### BACKGROUND ART

In general, due to the high color reproducibility and convenient design of AMOLED panels, application fields of the products are expanding to home appliances including television and various mobile products such as mobile phones and smart watches. In order for the AMOLED panel industry to further develop while expanding the application range to various products, it is necessary to implement ultra-high resolution and maintain a certain level of lifespan. To this end, the problems of MURA (screen stains) and image sticking (afterimages), which are known as the biggest shortcomings of AMOLED panels, must be solved. There are two main approaches to solving the MURA and image sticking problems. One is to improve the characteristics of the AMOLED panel itself, such as improving the circuit structure of the pixel or improving the characteristics of the panel process or materials used, and this is called “internal compensation.” The second is a method of measuring the characteristics of each pixel in an AMOLED panel made with the current level of technology using an electrical or optical method, and then using the measured data to compensate for the characteristics of each pixel using an image processing technique in the driving circuit, which is called “external compensation.”

Meanwhile, FIG. 1 shows the basic AMOLED pixel structure, and the AMOLED panel is composed of a matrix structure in which pixels configured as in FIG. 1 are arranged in multiple horizontal columns and vertical rows.

The operating state of the AMOLED pixel is explained with reference to FIG. 1 as follows.

Firstly, the TFT1 of the selected pixel is turned on through the Scan Driver, and a voltage corresponding to the image data is driven through the Data Driver so that the driven voltage fully charges Cl. Next, the TFT1 is turned off through the Scan Driver. TFT2 acts as a current source that converts the voltage written to Cl into current, and the OLED emits light in proportion to the amount of current generated by TFT2.

At this time, even if the driving circuit of the AMOLED Panel, such as the Scan Driver and Data Driver, inputs the same voltage to all pixels, the image quality of the AMOLED Panel may be distorted due to the deviation between the pixels of the TFT2 that acts as the current source and the deviation between the pixels of the OLED luminous efficiency. The deviation between the pixels of the TFT2 and the OLED may occur during the manufacturing process, or may be caused by deterioration during use and temperature deviation during operation. In order to compensate for the image quality distortion caused by the above factors, the deviation rate between the TFT2 and the OLED must be measured by an electrical or optical method, then digitized and stored in a memory device.

However, the conventional driving circuit for compensating for image quality distortion is structured to receive and process all of the data related to image quality distortion at once, requiring a high-spec IC (Integrated Circuit), which in turn increases the manufacturing cost, and causes problems such as heat generation and reduced operation speed due to complex operations.

### DISCLOSURE

### Technical Problem

The technical problem to be solved by the present invention is to provide a display driver IC for AMOLED image correction that classifies image quality distortion caused by various factors as described above according to the influence on each pixel and compensates for each.

### Technical Solution

In order to achieve the above technical task, the present invention provides display driver IC for AMOLED image correction, which is a display driver IC for AMOLED image correction for compensating for image quality distortion of an AMOLED panel, wherein the luminous efficiency deviation rate (ΔLU) of a light-emitting diode and the beta value deviation rate (ΔBeta) of a thin-film transistor are compensated by obtaining compensation data in a gamma curve domain between luminance and video data, and the threshold voltage deviation rate (ΔVT) of a thin-film transistor are compensated by obtaining compensation data in a gamma curve domain between luminance and driving voltage and then adding them together.

More specifically, the display driver IC for AMOLED image correction further comprises: a first compensation circuit unit which calculates the luminance to be implemented using the data received from the display data unit and the set first reference gamma curve, obtains a modified gamma curve using the data received from the first storage unit in which the luminous efficiency deviation rate (ΔLU) of the light-emitting diode and the beta value deviation rate (ΔBeta) of the thin film transistor are stored, and generates first compensation video data corresponding to the luminance to be implemented using the modified gamma curve; a conversion circuit unit which converts first compensation driving voltage data matching the first compensation video data into a digital value; and a second compensation circuit unit which calculates the driving voltage to be compensated using the data received from the second storage unit in which the threshold voltage deviation rate (ΔVT) of the thin film transistor is stored and the set second reference gamma curve, and generates second compensation driving voltage data by adding the driving voltage to the first compensation driving voltage data; A display driver IC for AMOLED image correction, comprising: a driving circuit unit for converting the secondary compensation driving voltage data into an analog value and outputting the converted analog value.

In addition, the first reference gamma curve is characterized by being composed of a gamma curve between luminance and data, and the second reference gamma curve is characterized by being composed of a gamma curve between luminance and driving voltage.

In addition, the driving circuit section is characterized by being implemented in a linear gamma manner.

### Advantageous Effects

By using the display driver IC for AMOLED image correction according to the present invention described above, factors for image quality distortion are classified into factors that are effective for compensation in the gamma curve domain between luminance and video data, and factors that are effective for compensation in the gamma curve domain between luminance and driving voltage, and compensation data is obtained in each domain and then summed, so that compensation data can be efficiently calculated with a small amount of calculation, thereby reducing the circuit area and reducing current consumption.

In addition, since the calculation speed is also improved, various image quality distortion factors can be accurately compensated for simultaneously compared to the conventional method.

### DESCRIPTION OF DRAWINGS

FIG. 1 is a circuit diagram showing a basic AMOLED pixel structure,

FIG. 2 is a diagram showing an original gamma curve and a gamma curve with a modified curvature between luminance and video data,

FIG. 3 is a diagram showing an original gamma curve and a gamma curve modified in a parallel shift manner between luminance and driving voltage,

FIG. 4 is a conceptual diagram showing the structure of a display driver IC for AMOLED image correction according to the present invention,

FIG. 5 is a conceptual diagram showing a luminance and video data domain compensation circuit according to the present invention.

### BEST MODE

Hereinafter, some embodiments of the present invention will be described in detail with reference to exemplary drawings. When adding reference numerals to components in each drawing, it should be noted that the same components are given the same numerals as much as possible even if they are shown in different drawings. In addition, when describing embodiments of the present invention, if it is determined that a specific description of a related known structure or function hinders understanding of the embodiments of the present invention, the detailed description thereof will be omitted.

In addition, when describing components of embodiments of the present invention, terms such as first, second, A, B, (a), (b), etc. may be used. These terms are only intended to distinguish the components from other components, and the nature, order, or sequence of the components are not limited by the terms. When it is described that a component is “connected,” “coupled,” or “connected” to another component, it should be understood that the component may be directly connected or connected to the other component, but another component may also be “connected,” “coupled,” or “connected” between each component.

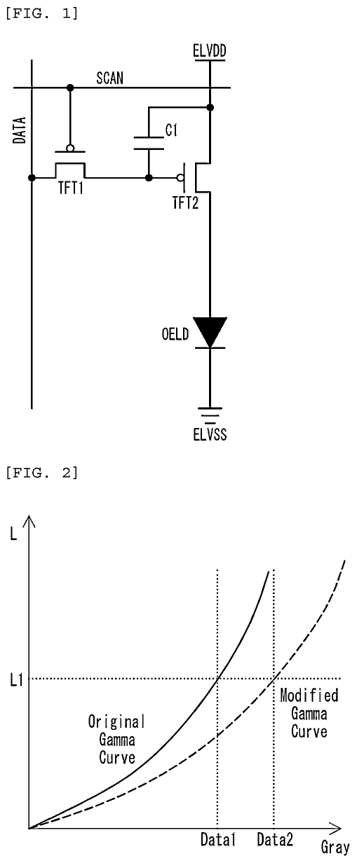

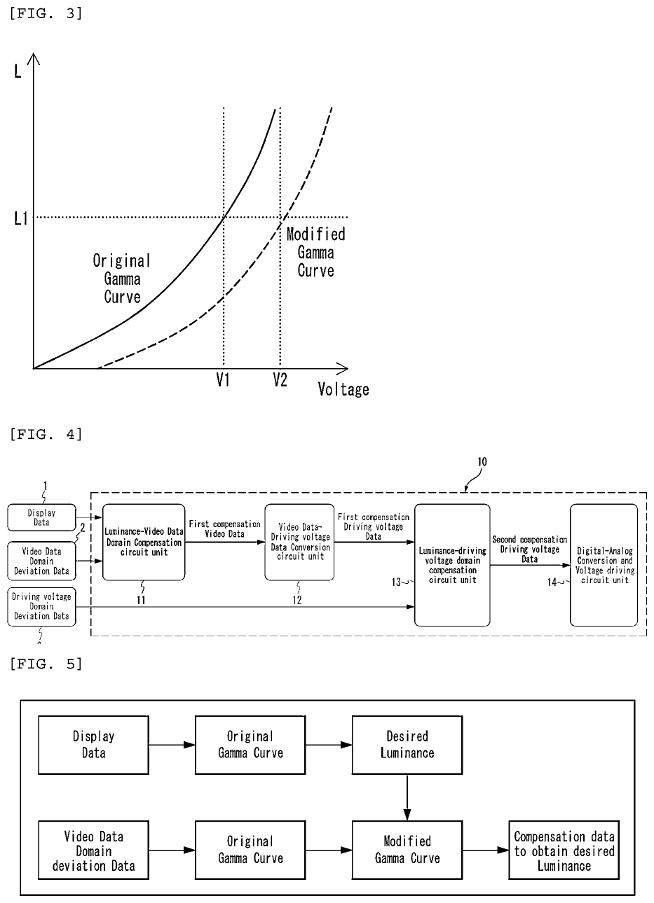

FIG. 2 is a diagram showing an original gamma curve between luminance and video data and a gamma curve with a modified curvature, FIG. 3 is a diagram showing an original gamma curve between luminance and driving voltage and a gamma curve with a modified curvature, FIG. 4 is a conceptual diagram showing the structure of a display driver IC for AMOLED image correction according to the present invention, and FIG. 5 is a conceptual diagram showing a luminance and video data domain compensation circuit according to the present invention.

Firstly, before explaining the present invention, factors causing image distortion of AMOLED panels can be broadly divided into three categories for convenience.

The first factor is the efficiency deviation of the light-emitting diode. The efficiency deviation of the light-emitting diode can be caused by dispersion in the manufacturing process, or by various factors such as efficiency reduction due to aging that occurs during the use of the AMOLED panel. The luminous efficiency deviation rate of each light-emitting diode, expressed as a percentage of the standard luminous efficiency of the light-emitting diode, is expressed as ΔLU.

The second factor is the beta value deviation of the thin film transistor used as the current source in the AMOLED pixel. The beta value deviation of the thin film transistor can also occur due to the process dispersion in the panel manufacturing process or due to changes in the characteristics of the thin film transistor during the process of using the AMOLED panel. The beta value deviation rate of the thin film transistor, expressed as a percentage compared to the process standard beta value of the thin film transistor, is expressed as ΔBeta.

The third factor is the threshold voltage deviation of the thin film transistor used as the current source in the AMOLED pixel. Like the second factor, the threshold voltage deviation of the thin film transistor can occur due to the process dispersion in the AMOLED panel manufacturing process or due to changes in the characteristics of the thin film transistor during the process of using the AMOLED panel. The threshold voltage deviation rate of the thin film transistor compared to the process standard threshold voltage of the thin film transistor is expressed as ΔVT.

Factors that cause image quality distortion in this way affect the gamma curve of the AMOLED panel as follows.

Firstly, the luminous efficiency deviation rate (ΔLU) of the light-emitting diode distorts the gamma curve by changing the curvature of the AMOLED panel gamma curve.

In addition, the beta value deviation rate (ΔBeta) of the thin film transistor also distorts the gamma curve by changing the curvature of the AMOLED panel gamma curve, just like the luminous efficiency deviation rate of the light-emitting diode.

The vertical axis of FIG. 2 represents luminance (brightness), and the horizontal axis represents video data. Referring to FIG. 2, if the curvature of the modified gamma curve is known, the corrected data (Data2) that generates the same luminance through the original gamma curve can be obtained.

In addition, the threshold voltage deviation rate (ΔVT) of the thin film transistor distorts the gamma curve by shifting the AMOLED panel gamma curve in a parallel direction to the right or left.

The vertical axis of FIG. 3 represents luminance (brightness), and the horizontal axis represents the driving voltage value. Referring to FIG. 3, if the parallel shifted state of the modified gamma curve is known, the corrected driving voltage value (V2) that generates the same luminance can also be obtained through the original gamma curve.

In other words, it can be seen that it is efficient to obtain correction data in the gamma curve domain between luminance and video data for image quality distortion due to the luminous efficiency deviation rate (ΔLU) of the light-emitting diode and the beta value deviation rate (ΔBeta) of the thin film transistor, and to obtain correction data in the gamma curve domain between luminance and driving voltage for image quality distortion due to the threshold voltage deviation rate (ΔVT) of the thin film transistor.

Based on these facts, the display driver IC for AMOLED image correction of the present invention (hereinafter referred to as ‘DDI 10’ classifies image quality distortion caused by various factors according to the influence on each pixel, and applies a method of compensating for each. That is, the luminous efficiency deviation rate (ΔLU) of the light-emitting diode and the beta value deviation rate (ΔBeta) of the thin-film transistor are compensated by obtaining compensation data in the gamma curve domain between luminance and video data, and the threshold voltage deviation rate (ΔVT) of the thin-film transistor are compensated by obtaining compensation data in the gamma curve domain between luminance and driving voltage, and then adding them up.

Referring to FIGS. 4 and 5 along with FIGS. 2 and 3, the detailed structure and operation state of the DDI 10 of the present invention will be described as follows.

The DDI 10 of the present invention may be configured to include a first compensation circuit unit 11, a conversion circuit unit 12, a second compensation circuit unit 13, and a driving circuit unit 14.

The first compensation circuit unit 11 receives data from the display data unit 1 and the first storage unit 2. The display data unit 1 is a part where actual display video data is input from the outside. The first storage unit 2 may be configured as a nonvolatile memory, and data on the luminous efficiency deviation rate (ΔLU) of the light-emitting diode and the beta value deviation rate (ΔBeta) of the thin film transistor may be stored.

The first compensation circuit unit 11 calculates the luminance to be implemented using the data received from the display data unit 1 and the set first reference gamma curve. Here, the first reference gamma curve can be understood as the original gamma curve (Gamma Curve) illustrated in FIG. 2, and the first reference gamma curve is composed of a gamma curve between luminance and data.

In addition, the first compensation circuit unit 11 receives the luminous efficiency deviation rate (ΔLU) of the light-emitting diode and the beta value deviation rate (ΔBeta) of the thin film transistor from the first storage unit 2, and obtains a modified gamma curve (a curve indicated by a dotted line in FIG. 2) using the first reference gamma curve. Thereafter, the first compensation video data (Data2) corresponding to the luminance to be implemented is generated using the modified gamma curve. At this time, the first compensation video data (Data2) can be found in various known ways, and for example, can be obtained by the following [Mathematical Formula 1]. Since the following [Mathematical Formula 1] is a known mathematical formula, a detailed explanation thereof will be omitted.

$$New Data = [ ( 1 + ΔBeta ( \% ) / 100 ) * ( 1 - Δ LU ( \% ) / 100 ) ] * ( - 1 / γ ) * ( Video Data ) \\ Where , ΔBeta is Beta deviation in percentage \\ Δ LU is luminance deviation in percentage \qquad [ Formula 1 ]$$

The above calculation formula or experimentally obtained data can be used to implement a look-up table method, and the data implemented in this way can be stored in the first compensation circuit unit 11.

Next, the conversion circuit unit 12 receives the first compensation video data from the first compensation circuit unit 11 and converts it into the first compensation driving voltage data matching it. At this time, the converted first compensation driving voltage data is a digital value.

Meanwhile, the second storage unit 3 can also be configured as a nonvolatile memory, and the threshold voltage deviation rate (ΔVT) data of the thin film transistor can be stored.

The second compensation circuit unit 13 receives threshold voltage deviation rate (ΔVT) data of the thin film transistor from the second storage unit 3, and calculates the driving voltage value (V2-V1) to be compensated using the set second reference gamma curve (the curve indicated by the solid line in FIG. 3) and the modified gamma curve (the curve indicated by the dotted line in FIG. 3). Here, the second reference gamma curve can be understood as the original gamma curve (Gamma Curve) illustrated in FIG. 3, and the second reference gamma curve can be composed of a gamma curve between brightness and driving voltage.

The second compensation circuit unit 13 adds the driving voltage value to be compensated to the first compensation driving voltage data to generate the second compensation driving voltage data. For example, if the first compensation driving voltage data is 4 V and the driving voltage value to be compensated 1 V, the second compensation driving voltage data can be 5 V, which is the sum of the two.

The driving circuit unit 14 converts the secondary compensation driving voltage data received from the second compensation circuit unit 13 into an analog value and outputs it. At this time, it is efficient to implement the driving circuit unit 14 in a linear gamma manner.

According to the DDI 10 capable of effectively compensating for the image quality distortion factors of the AMOLED panel described above, the image quality distortion factors are classified into factors that are effectively compensated for in the gamma curve domain between luminance and video data and factors that are effectively compensated for in the gamma curve domain between luminance and driving voltage, and compensation data is obtained in each corresponding domain and then added, thereby enabling efficient calculation of compensation data with a small amount of computation, thereby reducing the circuit area, reducing current consumption, and simultaneously and accurately compensating for various distortion factors compared to the past.

In the above, even though all the components constituting the embodiments of the present invention have been described as being combined or operating in combination, the present invention is not necessarily limited to these embodiments. That is, within the scope of the purpose of the present invention, all of the components may be selectively combined and operated in one or more. In addition, the terms “include,” “compose,” or “have” described above, unless otherwise specifically stated, mean that the corresponding component may be inherent, and therefore should be interpreted as including other components rather excluding other components. All terms, including technical or scientific terms, have the same meaning as generally understood by a person of ordinary skill in the art to which the present invention belongs, unless otherwise defined. Commonly used terms, such as terms defined in a dictionary, should be interpreted as being consistent with the contextual meaning of the relevant technology, and shall not be interpreted in an ideal or excessively formal meaning, unless explicitly defined in the present invention.

The above description is merely an illustrative description of the technical idea of the present invention, and those skilled in the art will appreciate that various modifications and variations may be made without departing from the essential characteristics of the present invention. Accordingly, the embodiments disclosed in the present invention are not intended to limit the technical idea of the present invention but to explain it, and the scope of the technical idea of the present invention is not limited by these embodiments. The protection scope of the present invention should be interpreted by the following claims, and all technical ideas within a scope equivalent thereto should be interpreted as being included in the scope of the rights of the present invention.

1. In a display driver IC for AMOLED (active matrix OLED) image correction to compensate for image quality distortion of an AMOLED panel,
a luminous efficiency deviation rate (ΔLU) of a light-emitting diode and a beta value deviation rate (ΔBeta) of a thin film transistor are compensated by obtaining a compensation data in a gamma curve domain between a luminance and video data, and a threshold voltage deviation rate (ΔVT) of the thin film transistor are compensated by adding each of the compensation data in the gamma curve domain between the luminance and a driving voltage.

2. The display driver IC for AMOLED image correction of claim 1, further comprising:
a first compensation circuit unit which calculates the luminance to be implemented using the data received from the display data unit and the set first reference gamma curve, obtains a modified gamma curve using the data received from the first storage unit in which the luminous efficiency deviation rate (ΔLU) of the light-emitting diode and the beta value deviation rate (ΔBeta) of the thin film transistor are stored, and generates first compensation video data corresponding to the luminance to be implemented using the modified gamma curve;
a conversion circuit unit which converts first compensation driving voltage data matching the first compensation video data into a digital value; and
a second compensation circuit unit which calculates the driving voltage to be compensated using the data received from the second storage unit in which the threshold voltage deviation rate (ΔVT) of the thin film transistor is stored and the set second reference gamma curve, and generates second compensation driving voltage data by adding the driving voltage to the first compensation driving voltage data; A display driver IC for AMOLED image correction, comprising: a driving circuit unit for converting the secondary compensation driving voltage data into an analog value and outputting the converted analog value.

3. The display driver IC for AMOLED image correction of claim 2, wherein the first reference gamma curve is a gamma curve between a luminance and a data.

4. The display driver IC for AMOLED image correction of claim 2, wherein the second reference gamma curve is a gamma curve between a luminance and a driving voltage.

5. The display driver IC for AMOLED image correction of claim 2, wherein the driving circuit is implemented in a linear gamma manner.
